(19) United States
(12) Patent Application Publication
(10) Pub. No.: US 2026/0177886 A1
(43) Pub. Date: Jun. 25, 2026

(54) HOUSING UNIT AND ELECTRONIC APPARATUS HAVING THE SAME

(71) Applicant: CANON KABUSHIKI KAISHA, Tokyo (JP)

(72) Inventor: SHIN ITAGAKI, Tokyo (JP)

(21) Appl. No.: 19/407,374

(22) Filed: Dec. 3, 2025

(30) Foreign Application Priority Data
Dec. 24, 2024 (JP) 2024-227662

(51) Int. Cl. G03B 17/08

(52) U.S. Cl. CPC G03B 17/08

(57) ABSTRACT

Housing units and electronic apparatuses are provided herein. A housing unit may include a first component having a first opposing surface, a second component having a second opposing surface opposite to the first opposing surface, a first member disposed in space formed by the first component and the second component, a connecting member configured to connect the first member and a second member disposed outside the space, an elastic member disposed on the first opposing surface, and a curable type gasket disposed on the second opposing surface and cured under a predetermined condition. The connecting member contacts the elastic member and the curable type gasket.

### BACKGROUND

### Field of the Technology

The aspect of the disclosure relates to one or more embodiments of a housing unit having a drip-proof structure, and an electronic apparatus having the same, such as a digital camera and a digital video camera.

### Description of the Related art

One of the conventional method applies a curable type gasket to a target component using an automated machine and then cures it to provide a drip-proof housing structure (see Japanese Patent Application Laid-Open No. 5-246456 A).

In a case where wiring for connecting the inside and outside of a housing is demanded to contact a curable type gasket, the gasket may be deformed to adhere closely to the wiring in order to maintain drip-proof performance, but the curable type gasket is little flexible and is difficult to deform. In a case where a curable type gasket is placed on only one of opposing surfaces of a plurality of components, a gap appears around the wiring.

### SUMMARY

One or more embodiments of a housing unit according to one or more aspects of the disclosure may include a first component having a first opposing surface, a second component having a second opposing surface opposite to the first opposing surface, a first member disposed in space formed by the first component and the second component, a connecting member configured to connect the first member and a second member disposed outside the space, an elastic member disposed on the first opposing surface, and a curable type gasket disposed on the second opposing surface and cured under a predetermined condition. The connecting member may contact the elastic member and the curable type gasket. An electronic apparatus may include one or more housing units in accordance with one or more other aspects of the disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view of an image pickup apparatus as an example of an electronic apparatus according to this embodiment of the disclosure.

FIGS. 2A, 2B, 2C, and 2D explain a housing unit.

FIG. 3 is an enlarged view of a portion C in FIG. 2D.

FIG. 4 illustrates a variation of a sealing method around a connecting member.

FIGS. 5A and 5B illustrate another variation of a sealing method around a connecting member.

FIG. 6 illustrates another variation of a sealing method around a connecting member.

FIGS. 7A and 7B illustrate variations of a sealing method around the connecting member.

FIGS. 8A, 8B, 8C, and 8D explain a wire retaining shape disposed in a second component.

### DESCRIPTION OF THE EMBODIMENTS

Referring now to the accompanying drawings, a detailed description will be given of embodiments according to the disclosure. Corresponding elements in respective figures will be designated by the same reference numerals, and a duplicate description thereof will be omitted.

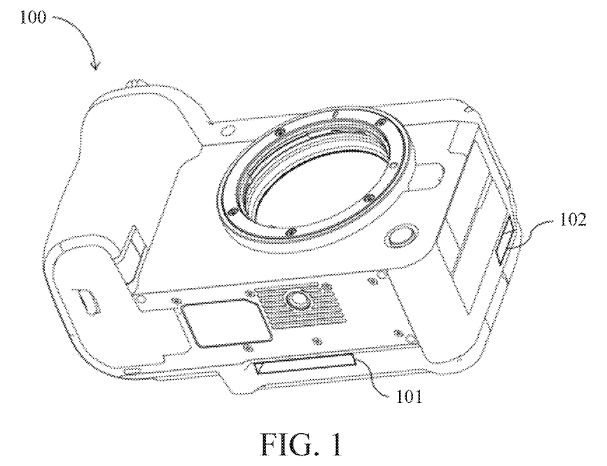

FIG. 1 is a perspective view of an image pickup apparatus 100 as an example of an electronic apparatus according to this embodiment of the disclosure. The image pickup apparatus 100 includes a housing unit 10 with a drip-proof structure. An intake port 101 and an exhaust port 102 provided in the image pickup apparatus 100 are connected to an intake port 21 and an exhaust port 22, respectively, of the housing unit 10.

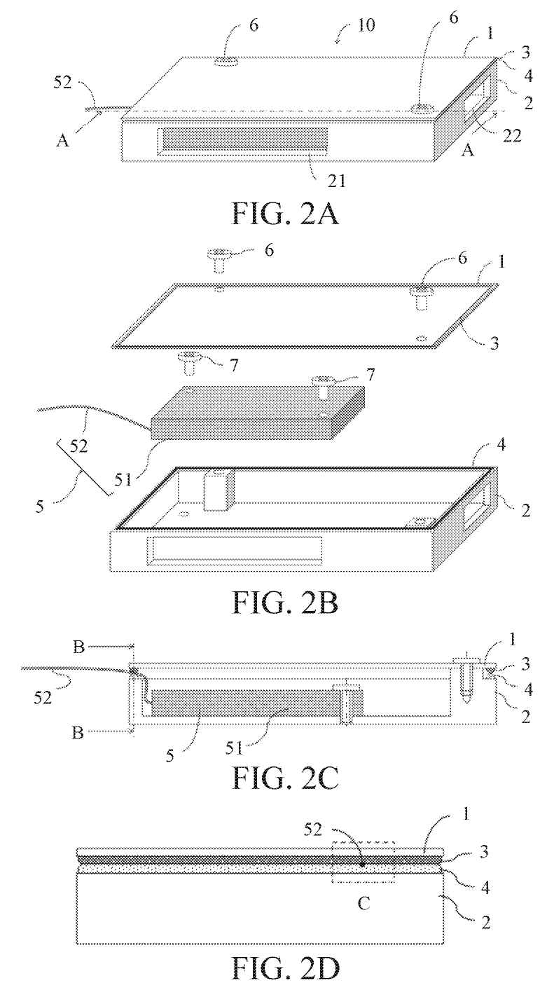

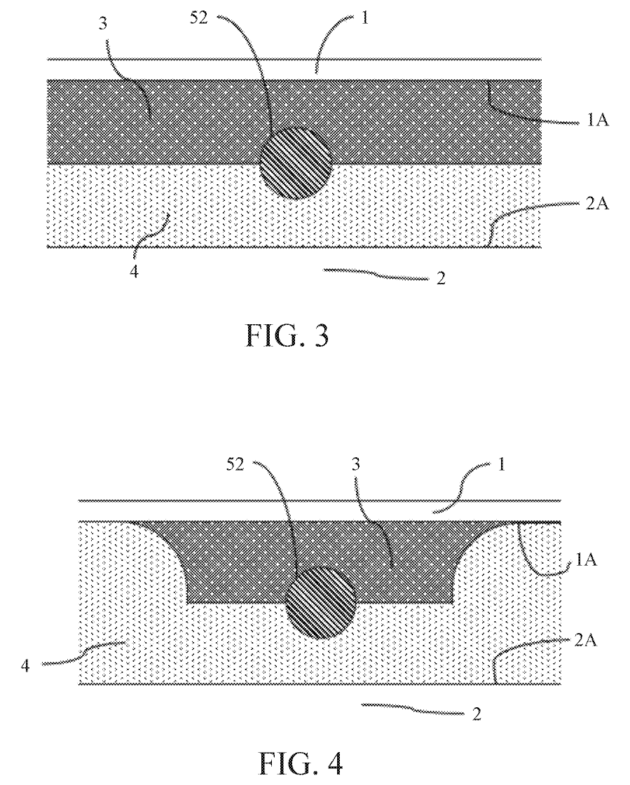

FIGS. 2A, 2B, 2C, and 2D explain the housing unit 10. FIGS. 2A and 2B are a perspective view and an exploded view of the housing unit 10, respectively. FIGS. 2C and 2D are a cross-sectional view taken along a line A-A in FIG. 2A and a cross-sectional view taken along a line B-B in FIG. 2C, respectively. FIG. 3 is an enlarged view of portion C in FIG. 2D.

The housing unit 10 includes a first component 1, a second component 2, an elastic member 3, a curable type gasket (first curable type gasket) 4, a fan unit 5, housing fastening screws 6, and fan-unit fastening screws 7.

The first component 1 is an approximately lid-shaped component and has an approximately rectangular opposing surface 1A that is engaged with the second component 2. The second component 2 is an approximately box-shaped component and has an approximately rectangular opposing surface 2A that is engaged with the first component 1. The fan unit 5 includes a motor 51 and a connecting member 52, and is fastened to the second component 2 with the fan-unit fastening screws 7. The motor 51 is disposed within the space formed by the first component 1 and the second component 2. The connecting member 52 is used to connect the first component (motor 51 in this embodiment) disposed within the space formed by the first component 1 and the second component 2 to a second component (not illustrated) disposed outside the space. In this embodiment, the connecting member 52 is wiring such as a power wire for connecting a power source to the motor 51, and is connected to the motor 51 and a connector for supplying power that is provided outside the housing unit 10 inside the image pickup apparatus 100.

The elastic member 3 is disposed on the opposing surface 1A of the first component 1. The curable type gasket 4 is placed on the opposing surface 2A of the second component 2.

The elastic member 3 is a sponge-like porous gasket that is softer and more flexible than the curable type gasket 4, and is fixed to the opposing surface 1A with double-sided tape. The curable type gasket 4 is applied in liquid state to the opposing surface 2A and cured under a specified condition. In this embodiment, the curable type gasket 4 is a curable type gasket (CIPG) that is cured under UV irradiation (ultraviolet irradiation). In a case where the first component 1 is fastened to the second component 2 with the housing fastening screws 6, the elastic member 3 is compressed and contacts the curable type gasket 4.

The connecting member 52 of the fan unit 5 is sandwiched between the elastic member 3 and the curable type gasket 4. That is, the connecting member 52 contacts the elastic member 3 and the curable type gasket 4. The elastic member 3 and the curable type gasket 4 deform to follow the shape of the connecting member 52, forming close contact.

In a case where a curable type gasket is applied to at least one of the opposing surfaces of two components and cured, if a connecting member passes between the opposing surfaces and the curable type gasket has a high hardness, the curable type gasket will not be able to conform to the shape of the connecting member and will not be able to provide drip-proof performance.

Accordingly, in this embodiment, the elastic member 3 and the curable type gasket 4 sandwich the connecting member 52 and contact it, thereby sealing the space between the first component 1 and the second component 2. As described above, the elastic member 3 is a sponge-like porous gasket with lower hardness and higher flexibility than those of the curable type gasket 4, and is therefore able to reliably conform to the shape of the connecting member 52. Thus, the sealing performance around the connecting member 52 can be improved. This prevents water that has entered the intake port 21 and exhaust port 22 in the housing unit 10 from leaking out from between the first component 1, the second component 2, and the connecting member 52.

In this embodiment, the elastic member 3 is a sponge-like porous gasket that provides flexibility for shape conformance, but it may also be CIPG, silicone resin, or FIPG, which have good shape conformance. A material may have low compression set so as to secure drip-proof performance and working performance during disassembly and reassembly, and the material may have low tackiness so as to prevent peeling or falling off during disassembly.

In this embodiment, the curable type gasket 4 is CIPG to automate the application step, but it may also be a flexible material such as silicone resin or FIPG, which have excellent flexibility. A material may have low compression set so as to secure drip-proof performance and working performance during disassembly and reassembly, and the material may have low tackiness so as to prevent peeling or falling off during disassembly.

In this embodiment, the curable type gasket 4 is cured by UV irradiation, but other methods such as curing by liquid mixing, thermal curing by heating, curing by reaction with moisture, curing by drying, and solidification by cooling may also be used.

While the connecting member 52 is used to transmit electricity, the disclosure is not limited to this example, as long as the shape allows the elastic member 3 and the curable type gasket 4 to conform to it. For example, it may be used for heat transmission, such as in a thermos-pipe or graphite sheet, power transmission, such as in a bicycle brake wire or hydraulic piping, or light transmission, such as in optical fiber.

As described above, the structure according to this embodiment makes it possible to maintain drip-proof performance while arranging the connecting member that connects the inside and outside of the housing at the abutting portion of the housing.

FIG. 4 illustrates a variation of a sealing method around the connecting member 52. The elastic member 3 is disposed in a range that overlaps the connecting member 52 on the opposing surface 1A when viewed from a direction perpendicular to the first opposing surface 1A and the second opposing surface 2A (first direction). The curable type gasket 4 is disposed in a range that overlaps the connecting member 52 on the opposing surface 2A (first range) and a range that does not overlap the connecting member 52 (second range) when viewed from a direction perpendicular to the first opposing surface 1A and the second opposing surface 2A. In this structure, the curable type gasket 4 disposed in the first area is thinner than the curable type gasket 4 disposed in the second area. Thereby, even if a reaction force is generated when the first component 1 and the second component 2 charge the curable type gasket 4, the curable type gasket 4 disposed in the first area is thin, so the elastic member 3 is not excessively crushed. Therefore, the elastic member 3 flexibly conforms to the shape of the connecting member 52, securing the drip-proof property. The area overlapping the connecting member 52 on the opposing surfaces 1A and 1B also includes the area that may overlap the connecting member 52.

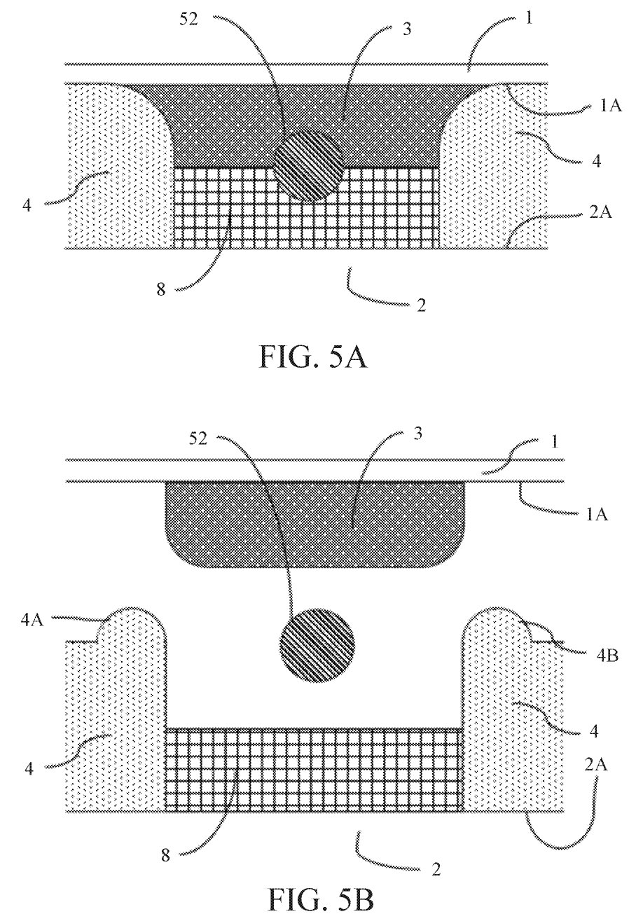

FIGS. 5A and 5B illustrate another variation of sealing methods around the connecting member 52. As illustrated in FIG. 5A, the elastic member 3 is disposed in an area overlapping the connecting member 52 on the opposing surface 1A when viewed from a direction perpendicular to the first opposing surface 1A and the second opposing surface 2A. The curable type gasket 4 is disposed in a range (second range) that does not overlap the connecting member 52 on the opposing surface 2A when viewed perpendicular to the first opposing surface 1A and the second opposing surface 2A. An elastic member (second curable type gasket) 8, which is a curable type gasket with hardness lower than that of the curable type gasket 4, is disposed in a range (first range) that overlaps the connecting member 52 on the opposing surface 2A when viewed perpendicular to the first opposing surface 1A and the second opposing surface 2A. In this structure, even if a reaction force is generated when the first component 1 and the second component 2 charge the curable type gasket 4, the elastic member 8 positioned in the first range contacts the elastic member 3, preventing excessive crushing of the elastic member 3. Therefore, the elastic member 3 flexibly follows the shape of the connecting member 52, securing drip-proof property. The range that overlaps the connecting member 52 on the opposing surfaces 1A and 1B also includes the range that may overlap the connecting member 52.

As illustrated in FIG. 5B, by providing a start point 4A and an end point 4B when applying the curable type gasket 4, the protrusions at the start point 4A and the end point 4B are also compressed when the first component 1 and the second component 2 charge the curable type gasket 4. In this structure, even if the start point 4A and end point 4B are compressed and the curable type gasket 4 deforms so as to protrude in the direction of the elastic members 3 and 8, the adjacent elastic members 3 and 8 flexibly follow, securing drip-proof performance. The start point 4A and end point 4B, which are the ends of the curable type gasket 4, may be located adjacent to the elastic member 8 (or may contact the elastic member 8).

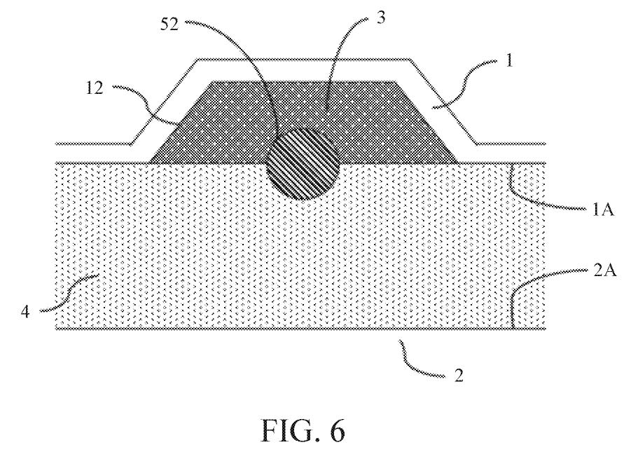

FIG. 6 illustrates another variation of a sealing method around the connecting member 52. A concave shape (concave portion) 12 is provided in the area that overlaps the connecting member 52 on the first opposing surface 1A and the second opposing surface 2A when viewed from a direction perpendicular to the first opposing surface 1A and the second opposing surface 2A. The elastic member 3 is disposed in the concave shape 12. A curable type gasket 4 is provided on the opposing surface 2A. In this structure, even if a reaction force is generated when the first component 1 and the second component 2 charge the curable type gasket 4, the elastic member 3 is installed in the concave shape 12, so the elastic member 3 is not excessively crushed. Thus, the elastic member 3 can flexibly follow the shape of the connecting member 52, securing drip-proof performance. The area of the opposing surface 1A that overlaps the connecting member 52 also includes an area that may overlap the connecting member 52.

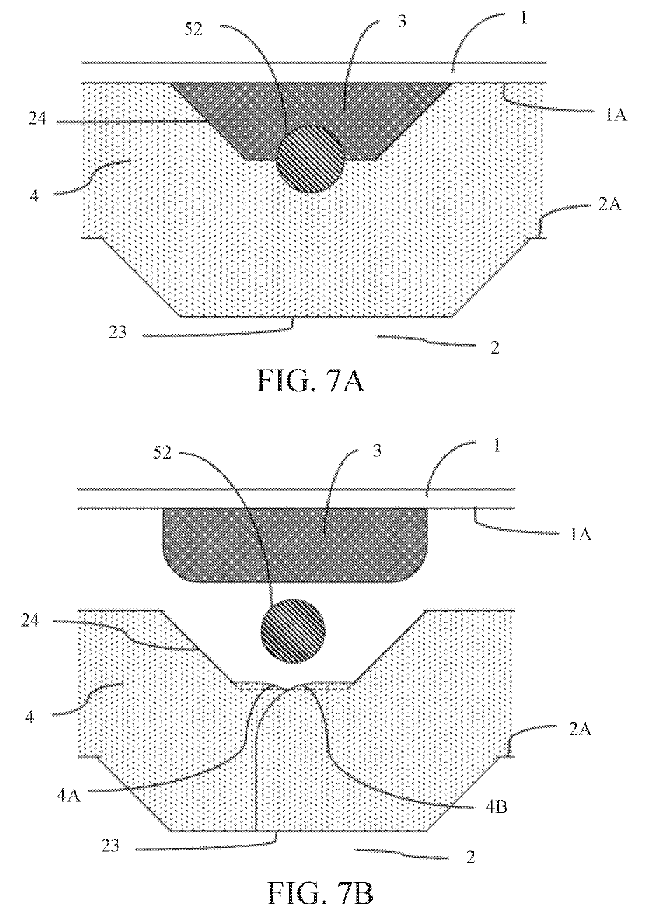

FIGS. 7A and 7B illustrate a variation of a sealing method around the connecting member 52. As illustrated in FIG. 7A, the elastic member 3 is disposed in an area that overlaps the connecting member 52 on the opposing surface 1A when viewed from a direction perpendicular to the first opposing surface 1A and the second opposing surface 2A. A concave shape 23 is provided in an area that overlaps the connecting member 52 on the opposing surface 2A when viewed from a direction perpendicular to the first opposing surface 1A and the second opposing surface 2A. The curable type gasket 4 is disposed in the concave shape 23. The opposing surface 2A also has a concave shape 24 that reflects the concave shape 23. In a direction perpendicular to the first opposing surface 1A and the second opposing surface 2A, the elastic member 3 overlaps the curable type gasket 4, which is disposed in a range that does not overlap the connecting member 52 on the opposing surface 2A when viewed from a direction perpendicular to the first opposing surface 1A and the second opposing surface 2A. In this structure, even if a reaction force is generated when the first component 1 and the second component 2 charge the curable type gasket 4, the curable type gasket 4 has the concave shape 24 that reflects the concave shape 23 on the opposing surface 2A, so the elastic member 3 is not excessively crushed. Therefore, the elastic member 3 can flexibly conform to the shape of the connecting member 52, securing drip-proof performance. The overlapping range of the opposing surfaces 1A and 1B with the connecting member 52 includes a range that may overlap the connecting member 52.

FIG. 7B is a variation of FIG. 7A, illustrating a raised portion that occurs when a start point 4A and an end point 4B are set when the curable type gasket 4 is applied to the concave shape 23 on the opposing surface 2A of the second component 2. Although the curable type gasket 4 increases in thickness due to the raised portion of the start point 4A and end point 4B, it can be accommodated within the concave shape 24 that reflects the concave shape 23 on the opposing surface 2A. Thereby, even if a reaction force is generated when the first component 1 and the second component 2 charge the curable type gasket 4, the concave shape 24 prevents the elastic member 3 from being excessively crushed. Thereby, the elastic member 3 flexibly conforms to the shapes of the connecting member 52 and the curable type gasket 4, securing drip-proof performance.

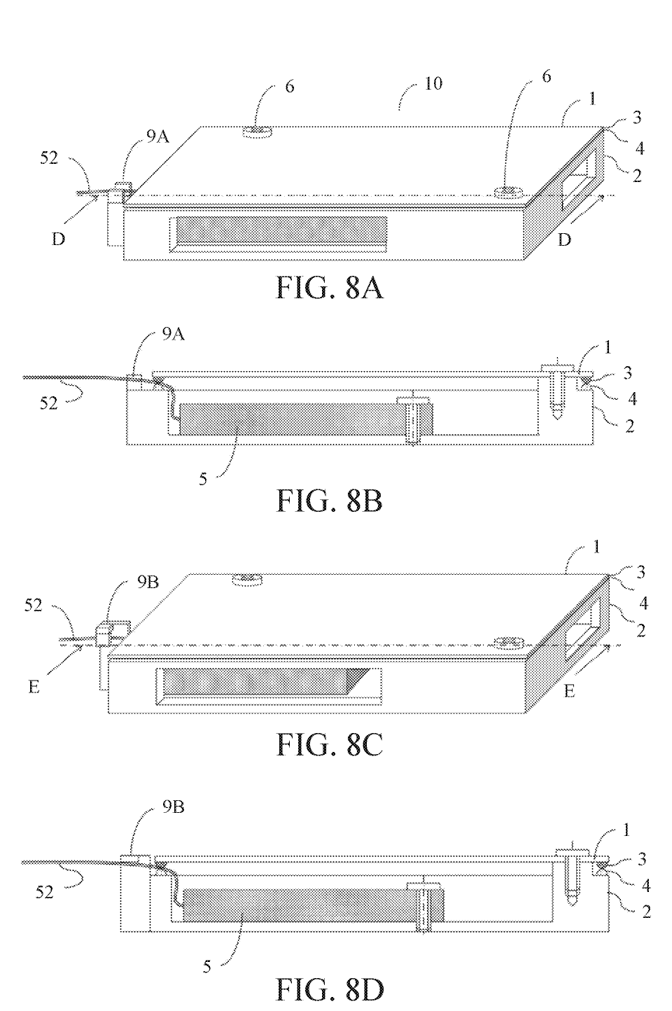

FIGS. 8A, 8B, 8C, and 8D explain a wire retaining shape (retainer) disposed on the second component 2. FIG. 8A illustrates a wire retaining shape 9A disposed on the second component 2. FIG. 8B is a cross-sectional view taken along a line D-D in FIG. 8A. The wire retaining shape 9A has two rod shapes. The connecting member 52 is maintained in a constant orientation by being sandwiched between the two rod shapes. Thereby, the connecting member 52 is located at a proper position against the elastic member 3 and the curable type gasket 4 between the opposing surfaces of the first component 1 and the second component 2. Therefore, the elastic member 3 and the curable type gasket 4 can flexibly conform to the shape of the connecting member 52, and secure drip-proof performance.

FIG. 8C illustrates the wire retaining shape 9B disposed on the second component 2. FIG. 8D is a cross-sectional view taken along a line E-E in FIG. 8C. The wire retaining shape 9B has a key shape. The connecting member 52 is retained in a constant orientation by being engaged with the key shape. Thereby, the connecting member 52 is located at a proper position against the elastic member 3 and the curable type gasket 4 between the opposing surfaces of the first component 1 and the second component 2. Therefore, the elastic member 3 and the curable type gasket 4 can flexibly conform to the shape of the connecting member 52, and secure drip-proof performance.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This embodiment and variations can provide a housing unit that can maintain drip-proof performance while placing a connecting member that connects the inside and outside of the housing at a contact portion of the housing.

This application claims the benefit of Japanese Patent Application No. 2024-227662, filed on December 24, 2024, which is hereby incorporated by reference herein in its entirety.

What is claimed is:

1. A housing unit comprising:
a first component having a first opposing surface;
a second component having a second opposing surface opposite to the first opposing surface;
a first member disposed in space formed by the first component and the second component;
a connecting member configured to connect the first member and a second member disposed outside the space;
an elastic member disposed on the first opposing surface; and
a curable type gasket disposed on the second opposing surface and cured under a predetermined condition,
wherein the connecting member contacts the elastic member and the curable type gasket.

2. The housing unit according to claim 1, wherein the elastic member is a porous gasket.

3. The housing unit according to claim 1, wherein the elastic member has hardness lower than that of the curable type gasket.

4. The housing unit according to claim 1, wherein the curable type gasket is cured by ultraviolet light irradiation.

5. The housing unit according to claim 1, wherein the connecting member transmits one of electricity, heat, power, and light.

6. The housing unit according to claim 1, wherein when viewed from a first direction perpendicular to the first opposing surface and the second opposing surface, the second opposing surface has a first area that overlaps the connecting member and a second area that does not overlap the connecting member, and
wherein the curable type gasket disposed in the first area in the first direction is thinner than the curable type gasket disposed in the second area in the first direction.

7. The housing unit according to claim 1, wherein the curable type gasket includes a first curable type gasket that does not contact the connecting member, and a second curable type gasket that contacts the connecting member and has hardness lower than that of the first curable type gasket.

8. The housing unit according to claim 7, wherein the second curable type gasket contacts an end of the first curable type gasket.

9. The housing unit according to claim 1, wherein the first opposing surface has a concave portion in which the elastic member is disposed.

10. The housing unit according to claim 1, wherein when viewed from a first direction perpendicular to the first opposing surface and the second opposing surface, the second opposing surface has a first area overlapping the connecting member and a second area not overlapping the connecting member,
wherein the second opposing surface has a concave portion provided in the first area, and
wherein the elastic member overlaps the curable type gasket disposed in the second area in the first direction.

11. The housing unit according to claim 10, wherein the concave portion contacts the curable type gasket disposed in the first area.

12. The housing unit according to claim 1, wherein the second component has a retainer that retains the connecting member so that the connecting member can maintain a predetermined orientation.

13. The housing unit according to claim 12, wherein the retainer has a shape that sandwiches the connecting member.

14. The housing unit according to claim 12, wherein the retainer has a shape that is engaged with the connecting member.

15. An electronic apparatus comprising:
a housing unit; and
a second member,
wherein the housing unit includes:
a first component having a first opposing surface;
a second component having a second opposing surface opposite to the first opposing surface;
a first member disposed in space formed by the first component and the second component;
a connecting member configured to connect the first member and the second member disposed outside the space;
an elastic member disposed on the first opposing surface; and
a curable type gasket disposed on the second opposing surface and cured under a predetermined condition,
wherein the connecting member contacts the elastic member and the curable type gasket.
